(19) United States
(12) Patent Application Publication
(10) Pub. No.: US 2014/0091962 A1
(43) Pub. Date: Apr. 3, 2014

(54) LEVEL GAUGE SYSTEM AND ADAPTOR WITH REFLECTOR

(71) Applicants: FRITZ LENK, Schiltach (DE); Joachim Benz, Hausach (DE); Klaus Kienzle, Zell A.H. (DE)

(72) Inventors: FRITZ LENK, Schiltach (DE); Joachim Benz, Hausach (DE); Klaus Kienzle, Zell A.H. (DE)

(73) Assignee: VEGA GRIESHABER KG, Wolfach (DE)

(21) Appl. No.: 13/795,759

(22) Filed: Mar. 12, 2013

(30) Foreign Application Priority Data
Apr. 4, 2012 (EP) 12 163 195.6

(51) Int. Cl. G01F 23/284

(52) U.S. Cl. CPC G01F 23/284
USPC 342/5

(57) ABSTRACT

A level measuring device with a signal generator for electromagnetic waves includes an elongated hollow waveguide or for guiding the generated electromagnetic waves, wherein on the end of the hollow waveguide a reflector is situated and a method for operating the same.

### CROSS REFERENCE TO RELATED APPLICATIONS

This application relates to, and claims priority from, European App. Ser. No. 12 163 195.6 filed Apr. 4, 2012, the entire contents of which are incorporated herein by reference.

### FIGURE SELECTED FOR PUBLICATION

FIG. 2

### BACKGROUND OF THE INVENTION

1. Field of the Invention

The present invention relates to the area of level measurement technology. More particularly, the present invention relates to the area of level measurement technology using radar, where electromagnetic waves that are guided by a hollow waveguide are used for level measurement.

2. Description of the Related Art

Level measuring devices are known from the conventional art with a signal generator for generating electromagnetic waves and an elongated hollow waveguide for guiding the generated electromagnetic waves. Such level measurement devices are used as a rule to measure the filling level of fluids, with the hollow waveguide configured as a cylindrical tube into which the filler material, i.e. especially the fluid, flows. At a boundary surface of the filling medium, the electromagnetic waves emitted and guided in the hollow waveguide are at least partially reflected, so that with the aid of a measurement of propagation time, the filling level of the medium within the hollow waveguide can be determined.

One such level measuring device is especially suited for fluids, for example solvents or fluid gases as well as fluids forming foam as well as for filler materials with low dielectric conductivity ∈.

Unfortunately, level measuring devices known from the conventional art has a problem in that at a level close to zero, i.e., when the measured signal is reflected in the area of an end of the hollow waveguide close to the container floor, a floor echo occurs, i.e., the electromagnetic wave is reflected on the mostly metallic floor of the container, which covers the measured signal, so that it is no longer possible to determine the filling level.

The regular measured signal, i.e., the reflection of the electromagnetic wave on the surface of the medium, is shown by line 23 in FIG. 4, and the ground reflection with a level measuring device as per the prior art at a filling level of approximately 0% is shown by line 24. As can be seen from FIG. 4, the ground reflection 24 completely covers measurement signal 23, so that it is not possible to detect measured signal 23.

Referring to FIG. 5 which shows an additional negative effect from the conventional art, in which, with a level measuring device with a hollow waveguide 45 cm long, which is mounted just over the bottom of a tank, in the range between 34 cm and 40 cm, interferences appear between the measured signal and the floor reflection, so that the detected signal starts to jump and therefore no meaningful measurement of the filling level is possible.

Accordingly, there is a need for an improved level measurement device, system, and method that addresses at least one of the concerns noted above.

### ASPECTS AND SUMMARY OF THE INVENTION

In response, it is now recognized that one aspect of the present invention is to make available a filling measurement device which does not exhibit the disadvantages from the prior art. In addition, one task of the present invention is to make available an option by which the disadvantages described above in level measuring devices from the prior art can be eliminated.

An invention-specific level measuring device exhibits a signal generator for generating electromagnetic waves and an elongated hollow waveguide for guiding the generated electromagnetic waves, with a reflector placed on the end of the hollow waveguide. Provision of a reflector as per this application means the placement of a reflecting surface at an angle deviating from the longitudinal axis of the hollow waveguide.

By provision of a reflector which preferably is configured as a plate portion or member and which is situated at the end of the hollow waveguide so that the generated electromagnetic waves emerge no farther in the direction of a bottom of a tank in which the filling level is to be determined, but rather are reflected away laterally by the reflector from the hollow waveguide, what is attained is that the bottom echo is in large part, and in an ideal case is almost totally, cut out. As a remaining echo at the end of the hollow waveguide, that share of the reflection is detected which is bounced back by the reflector into the hollow waveguide. However, this share is so reduced that it exhibits a smaller amplitude than a measured signal detected in this range, so that, owing to the reflector, a measured value can be determined in the end of the hollow waveguide also. The electromagnetic signal reflected laterally, for example in the direction of a container wall, does in fact continue to be detected by the level measuring device, but due to the increased propagation time, it lies outside the permissible measurement area and thus can be completely cut out when measurement values are generated.

Typically the hollow waveguide is configured as a tube, preferably as a cylindrical tube, although there is no limitation to this particular shape.

It has been shown that the reflector preferably should be aligned at an angle smaller than 75°, preferably between 35° and 55°, to the longitudinal axis of the hollow waveguide. Especially good results are obtained with the reflector aligned at an angle of 45° to the longitudinal axis of the hollow waveguide.

What is attained with the reflector aligned at an angle of 45° to the longitudinal axis of the hollow waveguide is that a relatively larger share of the electromagnetic signal is reflected out of the area of the hollow waveguide.

Fundamentally the reflector situated on the hollow waveguide can consist of any material that at least partially reflects electromagnetic waves. Accordingly, possible materials are plastics with an increased dielectric number and preferably metals.

One preferred embodiment of the reflector makes provision that the reflector is at least partially metallic, preferably metallized on a surface facing toward the hollow waveguide, for example dampened or imprinted.

A version of the reflector that is especially durable, mechanically and chemically, can be attained if the reflector is manufactured from a sheet, preferably from a steel sheet made of a chemically inert steel, for example a high-grade steel.

With such an embodiment of the reflector, in addition, in one embodiment of the hollow waveguide, likewise made of a steel, a connection can be produced especially simply between the reflector and the hollow waveguide by welding together.

One option for producing this connection is created by providing an arrangement of the reflector and an outer wall of the hollow waveguide. Along with the option to weld the reflector to the hollow waveguide, there also exists, especially with other materials, a possibility to adhesively bond the reflector and the hollow waveguide to each other, or to produce some other mechanical connection.

The mechanical stability of the arrangement can be increased if the reflector is connected not at points, but on a line-shaped section of the outer wall of the hollow waveguide. This way prevents the reflector from being all too easily separated, i.e. broken away, from the hollow waveguide under mechanical loading.

The reflector can, for example, be attached in linear fashion on the hollow waveguide, by having the hollow waveguide be cross-cut in the section of the outer wall on which the reflector is attached, at the angle in which the reflector is aligned.

In this way, at the end of the hollow waveguide, a front surface of the outer wall is created that is aligned to match the alignment of the reflector. Thus, the reflector in this area can be attached over the entire front surface to the hollow waveguide.

Preferably the reflector is situated on the hollow waveguide so that a point of intersection of the longitudinal axis of the hollow waveguide, which means as per this application an axis of hollow waveguide symmetry, especially a rotational axis of the hollow waveguide, with the reflector, is situated in front of the hollow waveguide. An arrangement of the point of intersection in front of the hollow waveguide means that this point of intersection especially does not lie within the hollow waveguide, but rather lies at least on a plane directed perpendicular to the longitudinal axis of the hollow waveguide at the height of the end of the hollow waveguide.

With the reflector aligned at an angle of 45° to the longitudinal axis of the hollow waveguide, this means that at least 50% of the surface of the reflector is aligned so that incident electromagnetic waves are reflected into an area outside the hollow waveguide.

Preferably the reflector is arranged so that it occludes a front surface of the hollow waveguide of at most 50%. Preferably the reflector occludes the front surface of the hollow waveguide by 30% at most, and more preferably not at all.

Occlusion of the front surface of the hollow waveguide as per this application means that by its being attached, the reflector reduces an imaginary front surface that lies perpendicular to the longitudinal axis of the hollow waveguide by the indicated share, i.e., that the corresponding share of the front surface is not allotted and in this area the reflector is situated.

Especially good results are obtained if a normal vector of the reflector lies in an oscillation plane of the magnetic field of the deflected electromagnetic waves.

The reflected electromagnetic waves are so-called TEM waves, known to those of skill in the art, in which the electrical and the magnetic components are orthogonal in pairwise fashion to the direction of electromagnetic wave propagation. In comparison to arrangements in which the normal vector is otherwise oriented, improvements of 4 to 6 dB are thus achieved.

The level measuring device from prior art, which operates according to the principle of electromagnetic waves guided by the hollow waveguide, can be improved by an adapter which exhibits an attachment section for end attachment of the adapter to an elongated hollow waveguide of the level measuring device, wherein a reflector is provided. The definition given above for attachment of a reflector also holds true for the invention-specific adapter.

Preferably the attachment section is configured to correspond to the hollow waveguide, so that the adapter can for example be placed on the hollow waveguide and connected to it by welding or adhesive bonding or by mechanical clamping.

For hollow waveguides configured as cylinders, it is preferred if the attachment section of the adapter is configured as a cylinder. In this way, the adapter can be situated in a favorable orientation for the particular purpose of use on the hollow waveguide. For example, it is thus possible to align the adapter so that waves reflected by the reflector have covered as long a distance as possible to the next container wall. However, it is also possible, as already described above, to align the adapter to be suited to the oscillation planes of the electrical and magnetic components of the electromagnetic field so that the reflections are especially well suppressed. Alignment in the direction of a distant container wall can be attained by an appropriate placement of the level measuring device in the container.

One proposed specific adapter can be manufactured in an especially favorable fashion if it is produced from plastic, for example. However, preferably the adapter is at least partly metallic, for example surface-metallized at least in the area of the reflector.

The adapter can be configured in especially stable fashion if it is produced from a sheet, preferably a steel sheet. Particularly with manufacture of the adapter from a steel sheet, the adapter can be connected in an especially simple and stable with a hollow waveguide that is also manufactured from steel, for example by welding together. However, fundamentally an adhesive bonding or some other mechanical connection of the components is also possible.

The reflector preferably should be aligned to the adapter at an angle smaller than 75°, preferably between 35° and 55°, to the longitudinal axis of the attachment section. Especially good results are obtained at an angle of 45°. What is attained with the reflector aligned at an angle of 45° relative to the attachment section of the attachment is that when the adapter is placed on the hollow waveguide of a level measuring device, the reflector is aligned relative to the hollow waveguide of the level measuring device.

Preferably the reflector is attached to an outer wall of the attachment section of the adapter. The attachment preferably is implemented in a linear section, so that in this way an especially stable connection can be attained.

To further increase the stability of the attachment of the reflector on the attachment section, in the section of the outer wall on which the reflector is attached, the attachment section is cross-cut at the angle at which the reflector is aligned.

A point of intersection of the longitudinal axis of the attachment section with the reflector preferably lies in front of the attachment section, since what is obtained in this way is that with the preferred alignment of the reflector at an angle of 45° to the longitudinal axis of the attachment section, at least 50% of the incident electromagnetic waves are reflected in an area outside the attachment section or the hollow waveguide.

Tests have shown that especially good results are achieved if the reflector is situated so that it occludes a front surface of the attachment section at most of 50%. Especially good results are obtained if the reflector occludes the front surface at most by 33%, and further preferred, does not occlude it.

It will be understood by those of skill in the art that the definitions provided above regarding the arrangement of the point of intersection of the reflector with the longitudinal axis of the hollow waveguide as well as regarding the occlusion of the front surface of the hollow waveguide are to be applied mutatis mutandis to the adapter. It will also be understood that the proposed device, adaptor, and systems therefore may be provide and operated as methods without departing from the scope and spirit of the present invention.

The above and other aspects, features and advantages of the present invention will become apparent from the following description read in conjunction with the accompanying drawings, in which like reference numerals designate the same elements.

### BRIEF DESCRIPTION OF THE DRAWINGS

FIG. 1 is an invention-specific level measuring device with an invention-specific adapter in a first embodiment form.

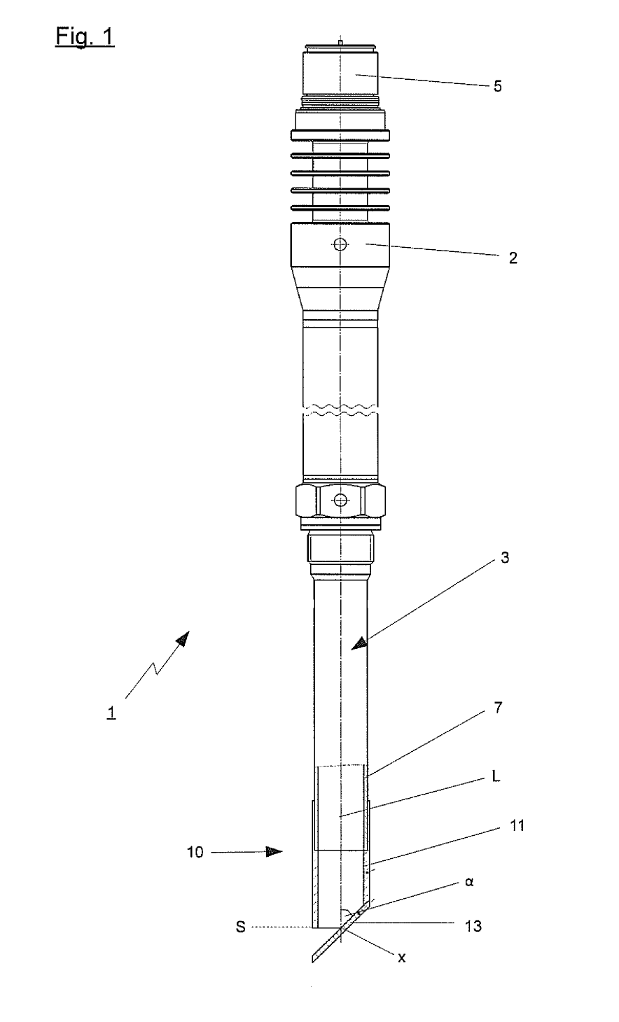

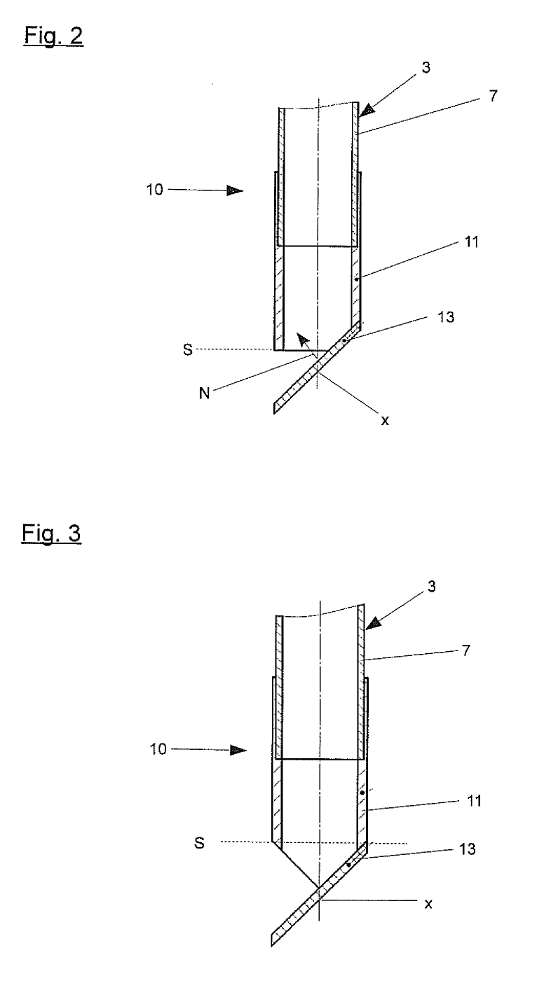

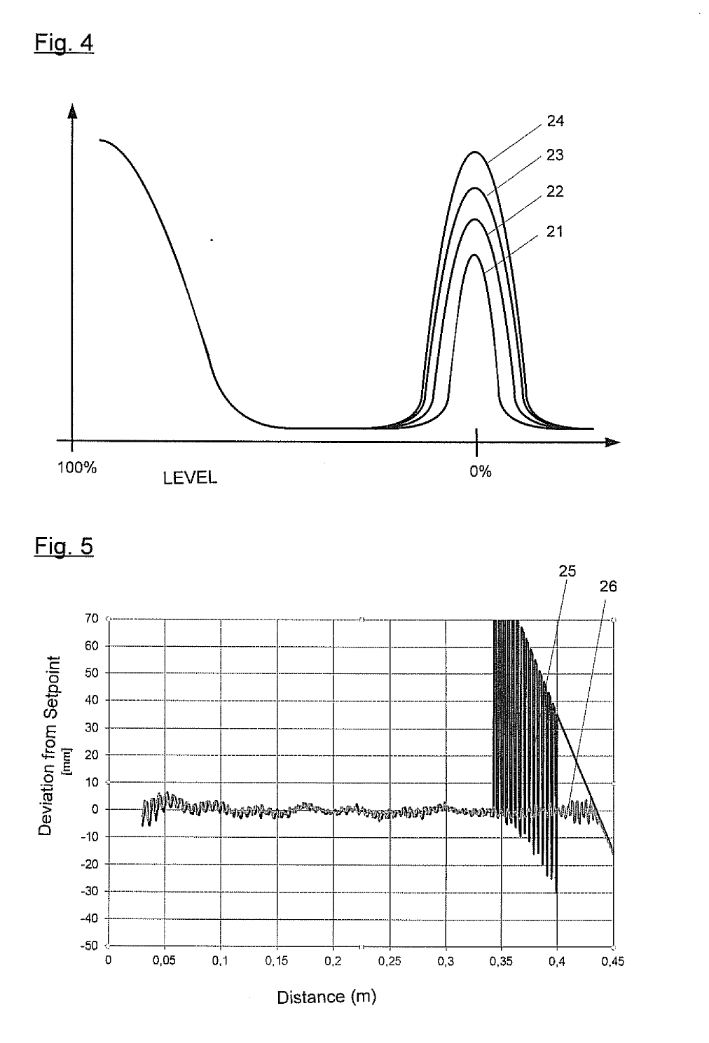

FIG. 2 is a vertical tube of a level measuring device with an adapter in a first embodiment.

FIG. 3 is a level measuring device with an invention-specific adapter according to a third embodiment.

FIG. 4 is a graph of echo curves depicted schematically

FIG. 5 is a graphical representation of a comparison of the deviations of a measured value from the de-facto filling level with level measuring devices.

### DETAILED DESCRIPTION OF THE PREFERRED EMBODIMENTS

Reference will now be made in detail to embodiments of the invention. Wherever possible, same or similar reference numerals are used in the drawings and the description to refer to the same or like parts or steps. The drawings are in simplified form and are not to precise scale. The word ‘couple’ and similar terms do not necessarily denote direct and immediate connections, but also include connections through intermediate elements or devices. For purposes of convenience and clarity only, directional (up/down, etc.) or motional (forward/back, etc.) or shape terms (cylindrical, cylindraceous, rectangular, planar, flat, etc.) terms may be used with respect to the drawings. These and similar directional terms should not be construed to limit the scope in any manner. It will also be understood that other embodiments may be utilized without departing from the scope and spirit of the present invention, and that the detailed description is not to be taken in a limiting sense, and that elements may be differently positioned, shaped, or otherwise noted as in the appended claims without requirements of the written description being required thereto.

Various operations may be described as multiple discrete operations in turn, in a manner that may be helpful in understanding embodiments of the present invention; however, the order of description should not be construed to imply that these operations are order dependent.

FIG. 1 provides a level measuring device 1, which operates according to the radar principle.

In a rear area behind an operative wave adapter 5, the level measuring device 1 exhibits and provides an operative signal generator as well as an electronic evaluation device, which is not depicted here but will be understood by those of skill in the art. The signal generator is understood as being appropriately configured to emit electromagnetic wave packets in a length of about 1 ns as well as a frequency of about 26 GHz. Additional frequencies typically used for level measurement are 5.8-6.3, 10, 24-27 or 75-83 GHz.

The electromagnetic waves are coupled via the wave adapter 5 into a hollow waveguide 3, which is also designated as a vertical tube, but which may be any other operative bounded hollow guide shape. The electromagnetic waves are guided in hollow waveguide 3 in the direction of the filler material and are reflected at a boundary surface between a filler medium and the medium found over it, particularly air or another gas. From measurement of a propagation time of the electromagnetic wave packets, a filling level within a container can then be computed. In addition to reflections on the boundary surface, i.e., the surface of the filler material, reflections are also evoked at the end of the hollow waveguide and at the container bottom. Especially in the prior art as a detriment, the bottom reflections result in measurement in the end area of hollow waveguide 3 no longer being possible with tubular antennas mounted close to the bottom, since the bottom echo, with its extremely high amplitude, completely blots out a measurement signal that is generated by the surface of the measured material. More detailed information about the corresponding effects will be dealt with at a later time and will be understood by those of skill in the art.

In addition the invention-specific level measuring device exhibits an adapter 10, on the front side of which a reflector 13 is situated. Alternatively, the reflector 13 can be situated directly on the hollow waveguide 3 for attachment to an adapter 10 without departing from the scope of the invention.

Relative to a longitudinal axis L of hollow waveguide 3, which, in the present embodiment example corresponds to the rotational axis of the cylindrically shaped hollow waveguide 3, the reflector 13 is inclined at an angle α. The angle α is chosen in the present embodiment example, which also provides especially good results, to be 45°, but can also deviate from this value within the scope of the present invention.

Reflector 13 shown in the present embodiment example is configured essentially to be plate-shaped (but may be other shapes operative to achieve the present invention), and is sized so that it exhibits at least the surface of the projection of a cross section of hollow waveguide 3 to a surface inclined according to the angle α. What is attained in this way is that all of the electromagnetic waves that are emitted from the front side of the hollow waveguide are detected by reflector 13 and are reflected according to the reflection laws to be applied.

In the present embodiment example, reflector 13 intersects a front surface S of the hollow waveguide in its diameter, so that 50% of front surface S is occluded by reflector 13 and in the area of the remaining 50%, between front surface S and reflector 13, a lateral opening is produced. The share of electromagnetic waves that are reflected away out of hollow waveguide 3, depends in essence on the angle α of reflector 13 as well as on the size of the opening that appears laterally (see FIGS. 1-3 generally). As described in the present embodiment example, reflector 13 is attached to an outer wall of an attachment section 11 of adapter 10. The attachment section 10 corresponds to hollow waveguide 3 in being cylindrically shaped and is pushed via an outer circumference of hollow waveguide 3 and connected with it, for example by adhesive bonding or welding, or by other operable means suitable.

The reflector 13 is also secured by being welded onto attachment section 11 but may be otherwise secured. In the present embodiment example, the attachment section 11 is cross-cut on the front side at an angle of 45°, so that an adjoining surface for reflector 13 is produced that inclines at an angle of 45°, on which reflector 13 is also welded.

FIGS. 2 and 3 show two additional embodiment examples of invention-specific adapters 10, wherein the reflector 13 occludes front surface S as per the embodiment example in FIG. 2 only by 33% and does not occlude it as per the embodiment example in FIG. 3. Expressed in other words, a section line of front surface S of hollow waveguide 3 or adapter 10 respectively and the reflector 13 is shifted by 33% of the diameter of front surface S in the direction of its center point.

In the embodiment example as per FIG. 3, the reflector 13 is situated directly on a circumferential line of front surface S, and merely for mechanical stabilization is braced by an extension of adapter 10 or of hollow waveguide 3 respectively. Viewed from front surface S, thus a point of intersection x between reflector 13 and longitudinal axis L of hollow waveguide 3 or of the adapter 10 respectively is always in front of front surface S.

While not limited hereto, especially good results were obtained if a normal vector N of reflector 13 lies in the oscillation plane of the magnetic share of the emitted electromagnetic waves. To guarantee this, naturally it is a prerequisite that the emitted electromagnetic waves be so-called TEM waves, i.e., linear-polarized electromagnetic waves, in which the electrical and magnetic field of the electromagnetic wave are perpendicular to each other and vanish in the direction of propagation.

FIG. 4 is a schematic depiction of echo curves at a filling level of 0%, i.e. when the filling level is in the area of the open end of hollow waveguide 3. Curve 21 shows the echo which arises at the open end of a hollow waveguide 3 as per the prior art, when it irradiates into free space, i.e. not into a container or tank.

Curve 22 shows the echo which is generated when employing an invention-specific level measuring device or when using a level measuring device with an invention-specific adapter.

Curve 23 shows the echo of a medium with a low dielectric number (such as ∈<2.5) was is the case, for example, with oils.

Curve 24 shows the echo that arises on a container bottom when the hollow waveguide 3 is mounted in an area close to the container bottom, and no reflector as per the present invention is provided.

As can easily be seen from FIG. 4 (as noted above), the bottom echo (curve 24) completely blots out the measurement signal (curve 23) generated by the medium, so that at a filling level of approximately 0% no reasonable measurements of the filling level are still possible.

What is achieved by the invention-specific measures is that the electromagnetic waves do not impinge on the container bottom, but are deflected laterally, and thus the bottom echo (curve 24) is avoided, and only the echo arising on the reflector (curve 22) is produced. However, the amplitude of the measuring signal (curve 23) in this area is markedly greater than the amplitude of the signal generated by the reflector (curve 22), so that in comparison to the prior art, measurements can be carried out down to a filling level of approximately 0%.

FIG. 5 shows two error curves for level measuring devices with a hollow waveguide 45 cm long. What is applied is the measurement error in mm versus the distance of the surface of the medium from the start of hollow waveguide 3, i.e. the part of hollow waveguide 3 that is open.

Curve 25 shows the measurement error with a level measuring device as per the prior art, and curve 26 shows the measurement error with an invention-specific level measuring device 1.

As can without doubt be gleaned from FIG. 5, the measurement error with the two measuring devices moves in a range of +/−5 mm in the range from 0 to 34 cm. Due to the bottom echo 24, starting at a value of 34 cm, the measurement error in the level measuring devices as per the prior art begins a pronounced jump, due to interferences, so that starting at the value of 34 cm, no more measured values can be determined.

With a level measuring device according to the present invention, it can be understood that even beyond 34 cm, up to a value of 44 cm, the measurement error continues to lie within the range of +/−5 mm. With an adapter 10 according to the present invention, or with a level measuring device with an invention-specific reflector 13, measurements can thus continue to be carried out to the end of the hollow waveguide 10 employed. As a result, it will be understood that the present invention, systems, and method may be adapted without departing from the scope and spirit of the present invention.

### LIST OF REFERENCE SYMBOLS

1 level measuring device
2 antenna
3 hollow waveguide or upright tube
5 wave adapter
7 outer wall
10 adapter
11 attachment section
13 reflector
21 reflection open tube
22 reflection with reflector
23 measurement signal
24 bottom reflection without reflector
25 error with prior art
26 error with invention
α angle
N Normal vector
S front surface
L longitudinal axis
x point of intersection

Those of skill in the art will also understand that the present inventive system additionally includes a method for operating the same to achieve at least one of the benefits noted above, the method including the assembly of the device and system and an operation thereof for improved measurement accuracy.

Having described at least one of the preferred embodiments of the present invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

What is claimed is:

1. A level measuring device, with an operative signal generator for generating electromagnetic waves and an elongated hollow waveguide for guiding the electromagnetic waves generated, said level measuring device comprising:
a reflector proximate an end of said hollow wave guide.

2. A level measuring device, according to claim 1, wherein:
said hollow waveguide is configured as one a tube and a cylindrical tube.

3. A level measuring device, according to claim 2, wherein:
said the reflector is aligned at a preset angle (α) smaller than 75°, to a longitudinal axis (L) of the hollow waveguide.

4. A level measuring device, according to claim 3, wherein:
said preset angle (α) is between 35° and 55°.

5. A level measuring device, according to claim 3, wherein:
said reflector is at least partially metallic.

6. A level measuring device, according to claim 5, wherein:
said reflector is situated on an outer wall of the hollow waveguide.

7. A level measuring device, according to claim 6, wherein:
said reflector is attached on a linear section of the outer wall of the hollow waveguide.

8. A level measuring device, according to claim 7, wherein:
said hollow waveguide is cross-cut in a section of the outer wall on which the reflector is attached, at the angle (α) at which the reflector is directed.

9. A level measuring device, according to claim 3, wherein:
a point of intersection of the longitudinal axis (L) of the hollow waveguide with the reflector is situated operably in front of the hollow waveguide.

10. A level measuring device, according to claim 3, wherein:
the reflector is so situated that it occludes a front surface of the hollow waveguide at most by 50%.

11. A level measuring device, according to claim 10, wherein:
said occlusion is at most by 33%.

12. A level measuring device, according to claim 3, wherein:
a normal vector of the reflector (13) lies in an oscillation plane of a magnetic field of the generated electromagnetic wave.

13. An adapter, said adaptor for a level measuring device which operates according to the principle of the electromagnetic wave guided by a hollow waveguide, comprising:
an attachment section for an end attachment of the adapter to an elongated portion of said hollow waveguide of the level measuring device;
a reflector situated proximate at a preset angle (α) smaller than 75° to a longitudinal axis (L) of the attachment section.

14. An adaptor, according to claim 13, wherein:
the attachment section is operably configured as a cylinder.

15. An adapter, according to claim 13, wherein:
the adapter is at least partially metallic in a sheet form.

16. An adapter, according to claim 14, wherein:
said reflector is aligned at an angle (α) between 35° and 55° to the longitudinal axis (L) of the attachment section.

17. An adapter, according to claim 15, wherein:
said reflector is situated on an outer wall of the attachment section.

18. An adaptor, according to claim 16, wherein:
said reflector is attached on a linear section of the outer wall of the attachment section.

19. An adaptor, according to claim 18, wherein:
the attachment section is cross-cut in a section of the outer wall on which the reflector is attached, at the angle (α) at which the reflector (13) is aligned.

20. An adaptor, according to claim 19, wherein:
a point of intersection of the longitudinal axis (L) of the attachment section with the reflector is situated in front of the attachment section.

21. An adapter, according to claim 20, wherein:
the reflector is operatively situated that it occludes a front surface of the hollow waveguide by at most 50%.
